(19) United States
(12) Patent Application Publication
(10) Pub. No.: US 2008/0021643 A1
(43) Pub. Date: Jan. 24, 2008

(54) Driving support apparatus and vehicle navigation apparatus

(75) Inventor: Seiji Nishiyama, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/819,760

(22) Filed: Jun. 29, 2007

(30) Foreign Application Priority Data
Jul. 20, 2006 (JP) 2006-198249

(51) Int. Cl. G01C 21/34; G01C 21/30

(52) U.S. Cl. 701/210

(57) ABSTRACT

A driving support apparatus in a vehicle includes a control circuit as well as a current position detection unit, a database, and other units. The driving support apparatus provides a guidance of an exit method from a one way road when the vehicle is detected to have entered the one way road in the wrong direction. The exit method from the one way road is searched for based on a road map in a map data input unit, and the exit method is provided for a driver of the vehicle from a display unit and/or a speaker.

### CROSS REFERENCE TO RELATED APPLICATION

This application is based on and claims the benefit of priority of Japanese Patent Application No. 2006-198249 filed on Jul. 20, 2006, the disclosure of which is incorporated herein by reference.

### FIELD OF THE DISCLOSURE

The present disclosure generally relates to a driving support system and apparatus for use in a vehicle.

### BACKGROUND INFORMATION

In recent years, various techniques for providing a guidance for a driver so as to prevent an automobile to enter into a one way road in a reverse direction by a mistake of a driver, or for warning a driver that the automobile is actually traveling in a wrong direction on the one way road have been proposed.

That is, for example, Japanese patent document JP-A-2000-337915 discloses a driving support apparatus that is capable of letting the driver know that the automobile is traveling reversely on the one way road when the driver has not noticed that his/her vehicle is traveling against a standard traffic direction of the one way road. However, the technique in the above disclosure only warns the driver about a reverse travel on the one way road, thereby not being capable of telling the driver how to maneuver the vehicle to resolve the current problematic situation of reverse travel on the one way road.

### SUMMARY OF THE DISCLOSURE

In view of the above and other problems, the present disclosure provides a driving support apparatus and a vehicle navigation apparatus having the driving support apparatus which provides an optimum exit method from a one way road when a vehicle is traveling reversely against a standard traffic on one way road.

The driving support apparatus includes a position acquisition unit that acquires a current position of a vehicle, a database that stores a road map, a traffic regulations information acquisition unit that acquires traffic regulations information of a road where the vehicle is currently traveling, a notification unit that provides a notification for a driver of the vehicle, and a guidance unit that provides for the driver of the vehicle a guidance of an exit method from a one way road through the notification unit. When the vehicle is detected to has entered the one way road in a wrong direction based on the traffic regulations information acquired by the traffic regulations information acquisition unit, the guidance unit searches in the database for an optimum method for exiting from the one way road, and provides the guidance of the exit method from the notification unit. In this manner, the driver of the vehicle can acquire information on how he/she exits from the one way road.

Further, when a navigation apparatus is constructed by having the driving support apparatus with an above-described function, the navigation apparatus is capable of providing an optimum exit method from the one way road with a consideration of a return route to an original navigation route when, for example, the driver of the vehicle has entered the one way road in the wrong direction by mistake on his/her way to a destination of a travel.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation apparatus in a first embodiment of the present disclosure;

FIG. 2 shows a flowchart of a process in a control circuit of the navigation apparatus in the first embodiment of the present disclosure;

FIG. 3 shows an illustration of a road and a vehicle in one step of the flowchart shown in FIG. 2;

FIG. 4 shows an illustration of the road and the vehicle in another step of the flowchart shown in FIG. 2;

FIG. 5 shows an illustration of the road and the vehicle in yet another step of the flowchart shown in FIG. 2; and

FIG. 6 shows a block diagram of a navigation apparatus in a second embodiment of the present disclosure.

### DETAILED DESCRIPTION

Embodiments of the present disclosure are described with reference to the accompanying drawings. In the following embodiments, the situations are illustrated as in the left hand traffic. However, the present disclosure is applicable to the right hand traffic by reversing the left-right relationship of the traffic.

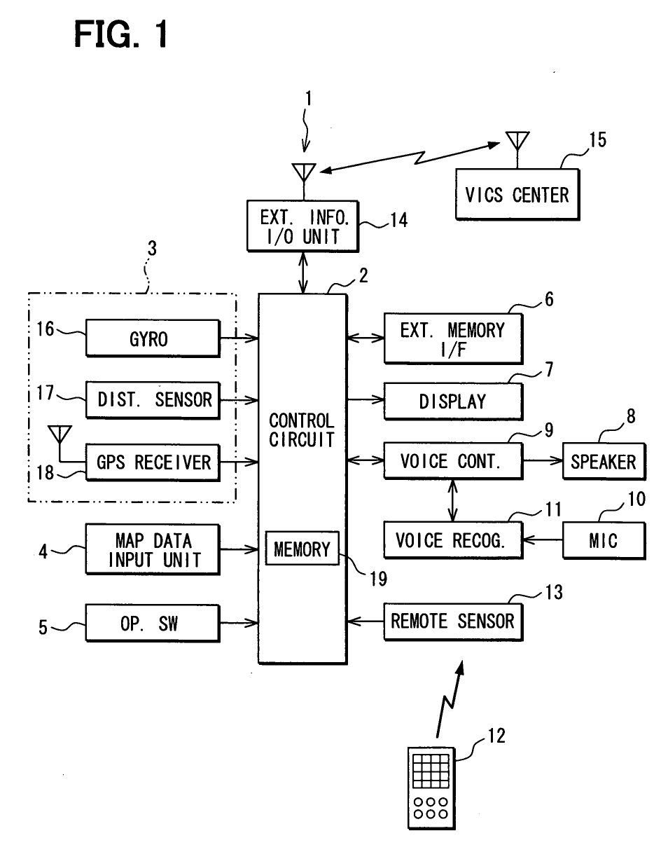

A first embodiment of the present disclosure is described in the following with reference to FIGS. 1 to 5.

FIG. 1 shows a schematic block diagram of a navigation apparatus in the first embodiment of the present disclosure. The navigation apparatus (a driving support device) 1 for vehicles includes a control circuit 2 mainly constructed by using a microcomputer, a position detector 3 to detect a position a vehicle, a map data input unit 4, operation switches 5, an external memory interface (I/F) 6, a display unit 7 having a color liquid crystal display panel or the like, a voice controller 9 to which a speaker 8 is connected to, a voice recognizer 11 recognizing a sound input from a microphone 10, a remote controller sensor 13 that transmits and receives commands to/from a remote controller 12 and an outside information input-output device 14 which, for example, transmits and receives data by radio communication between VICS (a registered trademark in Japan) center 15 and various kinds of clearing houses.

The position detector 3 has a gyroscope 16 for detecting an angular velocity of a vehicle, a distance sensor 17 detecting a mileage of a vehicle, a GPS receiver 18 for utilizing a Global Positioning System that detects (i.e., pinpointing) a current position of a vehicle based on a transmission of an electric wave from a satellite.

Each of the sensors 16-18 has an error of different nature. Therefore, the control circuit 2 uses detection values derived from respective sensors 16-18 by interpolating those values for accurately detecting the current position, a travel direction, a speed, a travel distance, a current time and the like of the vehicle. In this case, the respective sensors 16-18 may selectively be used depending on an accuracy. in addition, a steering rotation sensor, a wheel sensor of each tire and the like may also be used.

The map data input unit 4 is constructed by a drive device for reading data from map data recording media that stores various data such as road map data, mark data, data for map matching, destination data (i.e., a facility database), table data for converting traffic information into road data and the like. It is common to use macro-scale storage medium such as a DVD as the map data recording media, but mediums such as a memory card, an HDD may be used.

The road map data described above include data to display the road map on a screen of the display unit 7 by including data of a road shape, a road width, a road name, a signal, a railroad crossing, a building, various facilities, a place name, topography and the like. Further, the traffic regulations information such as one way traffic or DO NOT ENTER setting is stored in association with each of the roads when the road map data is configured to include those regulations information.

Further, destination data includes information on public transportation such as stations, recreation facilities, lodgings and accommodations, public facilities, commercial facilities such as retail stores, department stores, restaurants and the like, detached houses, apartment housings, place names and the like. The destination data also includes data attributes such as a telephone number and a street address of the facility, a latitude and longitude of the facility as well as data of landmarks in a proximity of the facility for showing an icon on a screen of the display unit 7 by superposing it on the road map.

Operation switches 5 are mechanical switches disposed in a proximity of the screen of the display unit 7, and/or are constructed as a touch panel on the screen of the display unit 7.

A user (i.e., a driver) inputs various commands to perform an input operation of a destination, information that are necessary for a destination search (i.e., destination search condition), passage points as well as a switch operation of a validation course/a validation spot (described later), the screen of the display unit 7, and display modes of the display unit 7 (i.e., a map scale change, menu selection, a route search, a course guidance start, a current position revision, volume adjustment and the like). In addition, plural operation switches are arranged on the remote controller 12, and various instruction signals are transmitted to control circuit 2 from the remote controller 12 through the remote controller sensor 13 by switch operation. In this case, operation switches 5 and the remote controller 12 are equivalent in terms of instructing the control circuit 2 to carry out a certain function invoked by the instruction operations provided on them.

For example, the external memory I/F 6 is, for example, an interface for a memory medium such as a flash memory card or the like, and is used for writing, in a route navigation operation by the control circuit 2, navigation route data toward the destination, vehicle passage route data and the like to a storage medium such as a memory card or the like in association with, for example, a navigation operation.

The display unit 7 displays on its screen a map around a position of the vehicle in various scaling as well as a current position mark (i.e., a pointer) that indicates the current position and a travel direction of the vehicle being superposed thereon. In addition, a screen for route navigation is displayed the route navigation to the destination is performed. Furthermore, an input screen for accepting user inputs of information that are required for a search of a destination as well as performing a destination search operation or a destination setting operation is displayed beside displaying various messages or the like.

The voice recognizer 11 compares a sound input through microphone 10 with dictionary data for voice recognition stored therein to recognize an input sound. The voice controller 9 controls the voice recognizer 11 to output a sound recognition result to the control circuit 2, and outputs a talkback of a recognized sound through the speaker 8. Further, the voice controller 9 outputs a sound output signal to the speaker 8 based on a sound output instruction from the control circuit 2. A sound output from the speaker 8 is a voice of guidance, a voice of operation explanation, the talkback voice mentioned above and the like.

The microcomputer of the control circuit 2 has a CPU, a memory 19 (e.g., a RAM, a ROM, an EEPROM, a flash memory and the like), an input/output (I/O) and the like. The control circuit 2 performs, by controlling the CPU to execute a program stored in the ROM or the flash memory, navigation functions such as destination setting, route search, display control, route guidance, passage route identification, function control, current position correction. The route search automatically calculates a recommendation of navigation route from a start of a travel (i.e., a current position) to the destination by using, for example, Dijkstra method.

The route guidance function displays the road map around the current position on the screen of the display unit 7 so as to enable a travel of the vehicle along the navigation route with the current position mark of the current vehicle position and the travel direction superposed on the road map. In this case, the current position mark moves over the map as the vehicle travels on the road, and the road map scrolls according to the position of the vehicle on the map. As the map scrolls, the position of the current position mark is matched on the road on the map by a map matching process.

The memory 19 of the control circuit 2 stores a travel history data of the vehicle. For example, the travel history data includes, for each of travel routes, a route number (i.e., a link ID), a date of travel, a departure time, an arrival time, a destination, a start point, a stop-by place, a fuel mileage, an average speed, a trace pointer and the like. The trace pointer is used to indicate a storage area of a travel route data.

The travel route data includes a spot number, a spot passage date and time, a spot position information (longitude/latitude). The spot is, for example in this case, a position of an intersection, a stop point or the like.

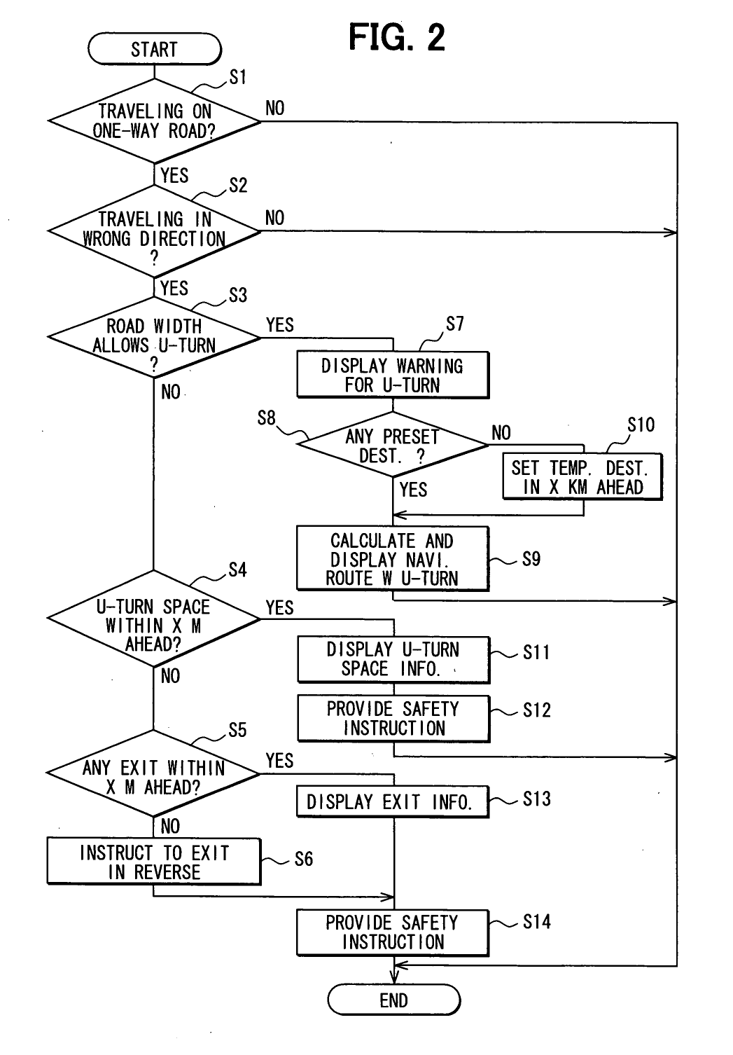

Operation of the present embodiment is explained with reference to FIGS. 2 to 5 in the following.

FIG. 2 is a flowchart to that shows a portion of a process in the control circuit 2 of the navigation apparatus 1 in terms of a main part of the present disclosure.

The control circuit 2 acquires the current position of the vehicle from position detector 3, and matches the current position with the road map of the map data input unit 4. Then, the control circuit 2 determines whether the road which the vehicle travels is a one way road (step S1), and further determines whether a travel direction of the vehicle is the reverse direction of the one way traffic (step S2) when the vehicle is traveling the one way road (step S1: YES).

When at least one of step S1 or S2 is determined as “NO,” the process in FIG. 2 is concluded and the process returns to a process for a normal navigation function.

In addition, when the process in step S2 determines the condition as “YES” due to the travel direction of the vehicle in reverse of the one way traffic, the control circuit 2 refers to the road map for determining the conditions of the road ahead of the current position of the vehicle sequentially in steps S3 to S5.

At first, in step S3, the process determines whether there is a sufficient road width for an easy U-turn at the current position of the vehicle.

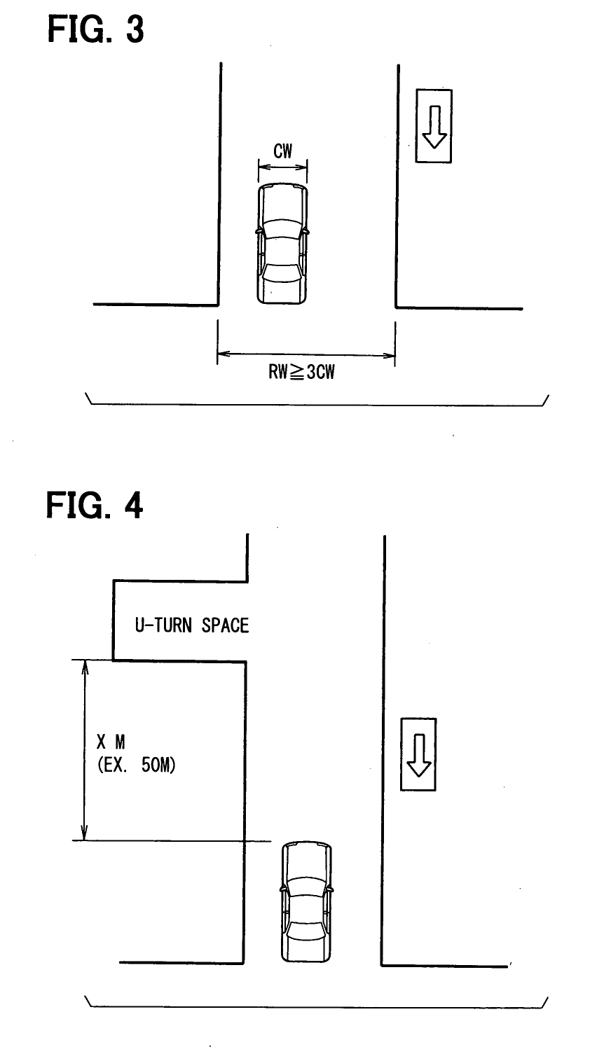

For example, the process determines, when a road width RW is equal to or greater than 3 times of a vehicle width CW (RW≧3CW), that there is a sufficient road width for an easy U-turn as shown in FIG. 3 (step S3: YES).

In this case, the control unit 2 warns a driver by outputting a voice signal from the speaker 8 and displaying a message on the display unit 7, and notifies the driver that it is possible to exit from the one way road by making a U-turn at the spot (step S7).

For example, the message that sounds like “Do not enter this road. Make a U-turn here and exit.” is output.

And, if a destination has been set to the navigation apparatus 1 at this point, and if it is in the middle of route navigation toward the destination (step S8: YES), the control circuit 2 re-searches for a route to the destination after the U-turn, and displays the re-searched route on the display unit 7 (step S9).

In addition, when a destination has not been set (step S7: NO), a temporary destination is set to a point x km ahead (for example, 1 km ahead) of the current position in the travel direction (step S10), and the process proceeds to step S9.

When the control circuit 2 determines that no easy U-turn is possible in step S3 (step S3: NO), the control circuit 2 determines whether there is a place for the vehicle to make a U-turn (or a change of a travel direction) within x meters (for example, 50 m) ahead of the vehicle in the travel direction, that is for example, a vacant land, a park space or the like (step S4, refer to FIG. 4).

And, if such a place exists (step S4: YES), the driver is notified that there is a place for making a U-turn ahead of the current position (step S11).

For example, the message that sounds like “Do not enter this road. There is a place for making a U-turn ahead on the left. Make a U-turn there and exit.” or the like is output.

Further, in this case, because the vehicle continues to violate traffic regulations by traveling in the same direction, the message that sounds like “The traffic regulation is violated. Please drive according to an actual traffic condition.” is output (step S12).

The second message is output for reminding the driver to abide by the traffic regulations and to perform an appropriate operation at the driver's own decision after the exit method is notified by the navigation apparatus 1 in step S11, because the traffic condition at the time of the notification such as an oncoming vehicle, an obstacle around the vehicle, a pedestrian or the like may not allow an immediate execution of the exit method as notified.

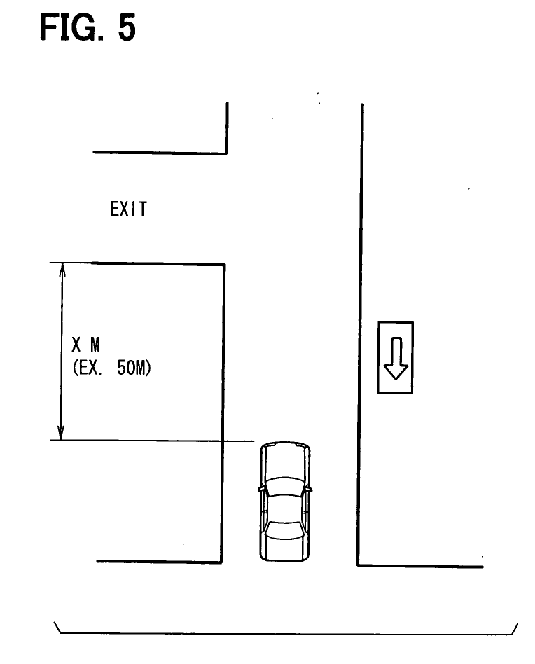

When the control circuit 2 determines that no easy U-turn is possible in step S4 (step S4: NO), the control circuit 2 determines whether there is a road such as a branch road or the like for the vehicle to exit from the one way road within x meters (for example, 50 m) ahead of the current position of the vehicle in the travel direction (step S5, refer to FIG. 5).

If there is a road for exiting from the one way road ahead (step S5: YES), the message is output to notify the driver that there is an exit from the one way road (step S13).

For example, the message that sounds like “Do not enter this road. There is an exit ahead on the left. Make a left turn there to exit.” or the like is output.

Then, the same warning as the one in step S12 is output in step S14.

When the control unit 2 determines that there is not exit ahead in step S5 (step S5: NO), the control unit 2 outputs a message that sounds like “Do not enter this road. Drive backward and exit from this road.” or the like is output for notifying the driver that the vehicle can exit from the one way road by driving backward (step S6).

Then, the process proceeds to step S14.

That is, when none of the conditions in steps S3 to S5 are met, the backward drive is advised because that is determined as the preferable method for exiting from the one way road.

When the control circuit 2 detects that the vehicle has entered the one way road in a reverse direction in the present embodiment as described above, the control circuit 2 searches for the most suitable exiting method from the one way road based on a road map of the map data input unit 4, and the exiting method is output from the display unit 7 and the speaker 8 as a guide for the driver.

Therefore, the driver is provided with the information on determining how to exit from the one way road that has been entered.

More practically, when the U-turn is possible in the one way road, the control unit 2 advises the driver to make the U-turn, thereby information for a prompt exit of the driver from the one way road is provided.

In addition, when there is a place that can let the vehicle make a U-turn within the predetermined distance ahead of the current position of the vehicle on the one way road, the place for making a U-turn is notified, thereby enabling the driver to make a U-turn (or to change directions) ahead of the current position to exit from the one way road even when the U-turn at the current position is difficult.

Furthermore, when an exit from the one way road exists within a predetermined distance from the current position, the driver is guided to enter into the exit, thereby encouraging the vehicle/the driver to exit from the one way road by using the exit even when the U-turn at the current position is difficult.

In addition, when the above-described method cannot be used as the guidance for exit, the driver is advised to travel backward, thereby encouraging the driver to immediately travel backward for an easy exit from the one way road even when the exit by the U-turn or the like is apparently difficult.

Furthermore, the control circuit 2 warns the driver that the driving operation should accord with an actual traffic condition as well as providing the method for exiting from the one way road, thereby encouraging the driver to perform an appropriate operation according to the actual traffic condition to exit from the one way road at the driver's own decision.

Furthermore, the navigation apparatus 1 records the traffic regulations such as the one way traffic or the like regarding the road map of the map data input unit 4, thereby enabling it easy for the driver to acquire the traffic regulations that are recorded in the road map.

Furthermore, when the driver has entered the one way road in the wrong direction by mistake in the course of tracing the navigation route toward the destination, an optimum exit method in terms of resuming the navigation route is provided for the driver.

### Second Embodiment

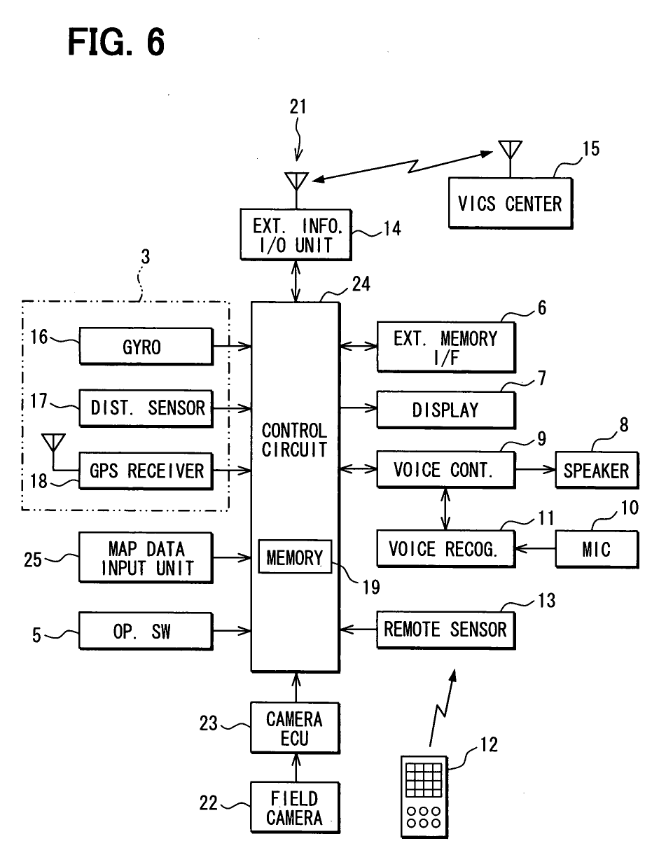

FIG. 6 shows a block diagram of a navigation apparatus in a second embodiment of the present disclosure. Like parts have like numbers as the first embodiment. The following description is focused to the difference from the portion that is different from the first embodiment of the present disclosure.

FIG. 6 is an equivalent of FIG. 1 in the first embodiment, and a navigation apparatus 21 in the second embodiment includes a field camera 22 and a camera ECU 23.

The field camera 22 is, for example, constructed by using a Charge Coupled Device (CCD), a CMOS image sensor and the like, and captures an image of an area that substantially exists in a front field of the vehicle for outputting image data to the camera ECU 23.

The camera ECU 23 is an interface between the control circuit 24 that replaces the control circuit 2 and the field camera 22, and performs the pattern recognition by processing the image data captured by the camera 22 to output to the control circuit 24 a recognition result of a traffic sign on the road such as a direction of an arrow of the “one way” sign or “Do Not Enter” sign when the traffic sign is recognized.

That is, in the second embodiment, the control circuit 24 acquires traffic regulations information based on the image data of the field cameras 22.

Therefore, in this case, the map data input unit 25 does not necessarily have the traffic regulations information stored in the road map.

The control circuit 24 as described above has the control circuit 24 that acquires the traffic regulations information of the traveling road based on the image data around the vehicle captured by the field camera 22, thereby providing the same effect as the first embodiment.

Although the present invention has been fully described in connection with the preferred embodiment thereof with reference to the accompanying drawings, it is to be noted that various changes and modifications will become apparent to those skilled in the art.

For example, the process that is performed based on the conditions in steps S3 to S5 as shown in FIG. 2 and/or the process in step S6 may be selectively performed as required.

Further, when the vehicle has entered into the one way road to a certain extent, the exit method from the one way road may be provided by comparing two distances of a forward exit and a backward exit from the current position of the vehicle. In this case, the exit method may be one of the forward exit and the backward exit that has a shorter distance for exit from the one way road.

Therefore, when a situation allows, the guidance message may sound like “Exit by continuing the forward travel in the current direction.”

Further, in that case, whether an oncoming vehicle is existing by the field camera as described in the second embodiment, and a suitable exit method is determined based on the detection result of the oncoming vehicle.

That is, for example, the backward exit may be advised in case that an oncoming vehicle exists even when the forward exit has a shorter distance.

The notification for the driver may be provided from only one of a display on the display unit 7 and a sound output from the speaker 8.

The relationship of the vehicle width CW and the road width RW that are used for determining the possibility of making a U-turn is provided as an example in the above embodiments and may be changed according to a situation. The distance from the current position to the U-turn space designated as x meters/x kilometers may also be changed according to the situation.

Further, when the destination has not yet been set, the process in step S10 may not necessarily be performed, with only providing a guidance in step S7.

The driving support apparatus of the present disclosure may not necessarily have all of the functions that are required for a navigation apparatus.

Such changes and modifications are to be understood as being within the scope of the present invention as defined by the appended claims.

What is claimed is:

1. A driving support apparatus comprising:
a position acquisition unit that acquires a current position of a vehicle;
a database that stores a road map;
a traffic regulations information acquisition unit that acquires traffic regulations information of a road where the vehicle is currently traveling;
a notification unit that provides a notification for a driver of the vehicle; and
a guidance unit that provides for the driver of the vehicle a guidance of an exit method from a one way road from the notification unit,
wherein, when the vehicle is detected to have entered the one way road in a wrong direction based on the traffic regulations information acquired by the traffic regulations information acquisition unit, the guidance unit searches in the database for an optimum method for exiting from the one way road, and provides the guidance of the exit method from the notification unit.

2. The driving support apparatus as in claim 1,
wherein, when the one way road is a road that allows a U-turn of the vehicle, the guidance unit provides a guidance for the U-turn.

3. The driving support apparatus as in claim 1,
wherein, when there is a place that allows a U-turn of the vehicle within a predetermined distance ahead on the one way road, the guidance unit provides a guidance to go to the place that allows the U-turn.

4. The driving support apparatus as in claim 1,
wherein, when there is an exit that allows an exit of the vehicle from the one way road within a predetermined distance ahead on the one way road, the guidance unit provides a guidance to enter into the exit that allows the exit from the one way road.

5. The driving support apparatus as in claim 2,
wherein, when the one way road does not allow the U-turn of the vehicle, the guidance unit provides a guidance of a backward travel of the vehicle.

6. The driving support apparatus as in claim 1,
wherein the guidance unit warns the driver of the vehicle that the vehicle is ought to be driven according to an actual traffic condition besides providing the guidance of the exit method.

7. The driving support apparatus as in claim 1,
wherein the database serves as the traffic regulations information acquisition unit by storing the traffic regulations information of the road.

8. A vehicular navigation apparatus constructed by having the driving support apparatus as in claim 1.
